(19) United States
(12) Patent Application Publication
(10) Pub. No.: US 2009/0050413 A1
(43) Pub. Date: Feb. 26, 2009

(54) CLAMP FORCE CONTROL

(76) Inventor: Hans Nilsson, Umea (SE)

Correspondence Address: RENNER OTTO BOISSELLE & SKLAR, LLP, 1621 EUCLID AVENUE, NINETEENTH FLOOR, CLEVELAND, OH, 44115, US

(21) Appl. No.: 11/816,175

(22) PCT Filed: Feb. 14, 2006
(86) PCT No.: PCT/SE2006/000202

§ 371 Date: May 27, 2008

(30) Foreign Application Priority Data
Feb. 14, 2005 (SE) 0500342-1

(51) Int. Cl. B66F 9/22

(52) U.S. Cl. 187/234

(57) ABSTRACT

A clamp force control (30) for a fluid powered clamping and lifting assembly (10) adapted to clamp and lift objects (20) by friction engagement in clamping and lifting operations by clamping pressure in a clamping pressure line (32) and lifting pressure in a lifting pressure line (58) provided for respective clamping actuators (16) and lifting actuators (12) of the assembly. To enable the control to safely adapt the clamping force to the lifting force without using electronic control equipment when handling different objects, the control has an adjustable pressure amplifier (52) provided in fluid connection (50) between the clamping pressure line (32) and the lifting pressure line (58) and adapted to provide a predetermined, constant difference between the lifting pressure and the clamping pressure.

### TECHNICAL FIELD

This invention relates to a clamp force control for a fluid powered clamping and lifting assembly adapted to clamp and lift objects by friction engagement in clamping and lifting operations by clamping pressure in a clamping pressure line and lifting pressure in a lifting pressure line provided for respective clamping actuators and lifting actuators of the assembly.

### BACKGROUND

Such a gripping assembly is typically used for handling paper rolls for printing machines. The rolls must be handled very carefully and may particularly not be clamped so hard by the gripping arms that they become oval. An oval roll causes problems in the printing machine which then has to be operated by reduced velocity. In the worst case the oval roll may cause a break of the paper web

The most common measure is that the clamping force is adjusted to a compromise value by a relief valve of the clamp assembly, more specifically to such a low clamp force as possible for being capable of lifting the heaviest roll that is to be handled.

A self-regulating control of the kind indicated above is disclosed in U.S. Pat. No. 6,027,302. This control uses a pressure sensor to sense the lifting pressure and an electronic control unit to continuously control the clamping pressure in proportion to that lifting pressure. As an electronic control unit is rather expensive, there may be a need, for example, for smaller printing houses of a simple and durable non-electronic clamp force control.

### SUMMARY OF THE INVENTION

An object of the invention is therefore to provide a control of the kind indicated above that without electronic control is able to safely adapt the clamping force to the lifting force when handling objects and that can be adjusted when necessary to handle different objects.

This object is obtained by the features defined in the appended claims.

In an aspect of the invention there is used an adjustable pressure amplifier provided in fluid connection between the clamping pressure line and the lifting pressure line and adapted to provide a predetermined, constant difference between the lifting pressure and the clamping pressure.

A pilot-controlled relief valve capable of sensing differential pressure can be used as a pressure amplifier. Other usable pressure amplifiers may be sequence valves, throttle valves or other types of relief valves.

A locking valve can be provided in the fluid connection between the clamping pressure line and the lifting pressure line to prevent accidental pressure transfer from the clamping pressure line to the lifting pressure line.

A pressure switch for sensing fluid pressure in a return line for said clamping actuator can be provided for signalling opening of the locking valve to allow transfer of fluid pressure from the clamping pressure line to the lifting pressure line when the pressure in the return line is below a predetermined level.

Further, a reduction valve can be provided to reduce the clamping pressure to a low initial pressure before each clamping and lifting operation in order to clamp the object by a low, non-destructive force

The invention also relates to a clamping and lifting assembly provided with a clamp force control according to the invention.

Other features and advantages of the invention are apparent from the following detailed description and from the claims.

### BRIEF DESCRIPTION OF THE DRAWING

FIG. 1 is a perspective view of a load handling unit to which the invention is intended to be applied;

FIG. 2 is a circuit diagram showing a clamp force control according to the invention connected to a clamping and lifting assembly; and

FIG. 3 is a circuit diagram showing a modified clamp force control according to the invention.

### DETALJERAD BESKRIVNING AV UTFÖRINGSEXEMPEL

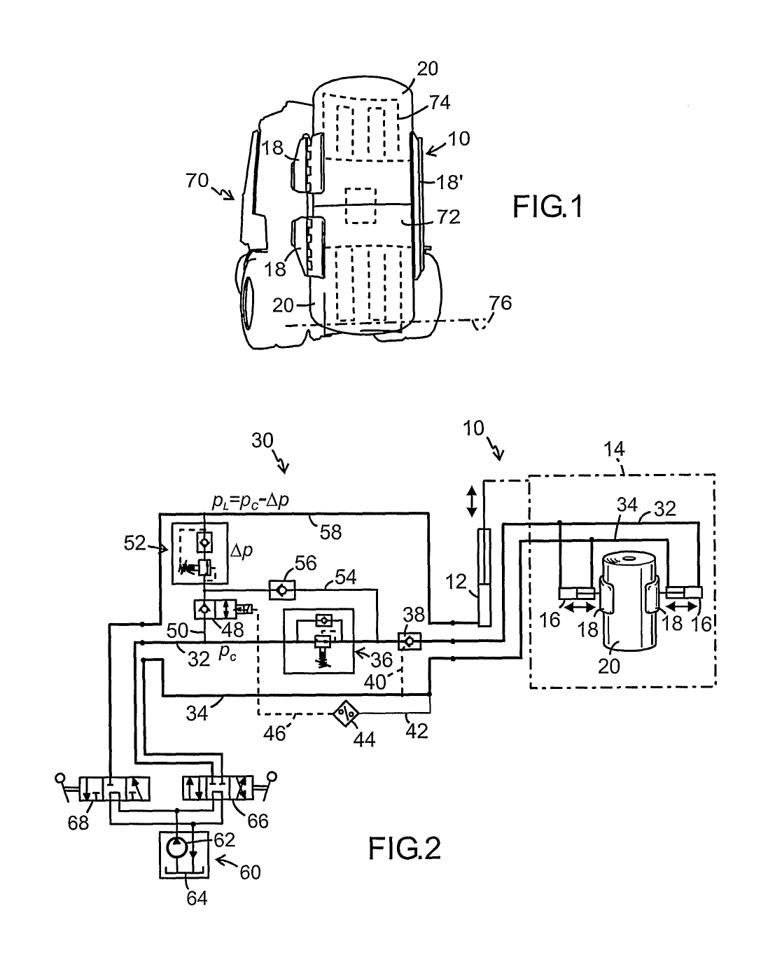

FIG. 1 shows a carrier or a vehicle 70 such as a fork lift truck, an articulated wheel loader or the like having mounted thereon a load handling device in the shape of a a clamping and lifting assembly 10. The clamping and lifting assembly, in this example showing the possibility of gripping and lifting two rolls 20 at the same time, comprises an arrangement of gripping arms 18, 18 and 18′. The gripping arms are mounted on a frame 72 capable of being raised and lowered on a generally vertical stand 74 which is swingable or tiltable relative to the truck 70 about an axis 66. The frame 72 may also be rotatable about a horizontal axis with respect to the stand 74, so as to enable the rolls 20 to be brought to a horizontally lying position (not shown).

The circuit diagram of FIG. 2 shows a combined clamping and lifting assembly generally designated by 10 and provided with a clamp force control 30 according to the invention.

The gripping movements of the gripping arms 18 are operated by clamping actuators 16 in the shape of double acting hydraulic cylinders fed with clamping pressure through a clamping pressure line 32 and with opening pressure through a line 34 which, for the sake of simplicity, may be referenced as a return line, i.e. it can be open to tank when the clamping pressure is applied. It is to be noted that the arrangement of gripping arms and clamping actuators is only shown diagrammatically in FIG. 2. The transfer of forces therebetween often makes use of lever or linkage mechanisms (not shown). The gripping arms may also be configured in different ways and numbers to handle one or more rolls at the same time (not shown).

In a known manner not shown, the lifting assembly 10 in turn comprises a lifting actuator 12 in the shape of one or more single-acting hydraulic cylinders 12 (only one is shown) that is capable of raising and lowering the clamping assembly 14 via a sliding guide (not shown) along the stand 74 (FIG. 1). The actuator 12 is fed by lifting pressure via a lifting pressure line 58.

The pressure of the hydraulic system is produced in a known manner by a hydraulic power assembly 60 having a hydraulic pump 62 and a tank 64. The pressure is distributed to the lines 32, 34, 58 mentioned above through a pair of directional valves 66, 68 controlled by the operator of the load handling device.

The clamp force control 30 of the invention will now first be described with reference to FIG. 1.

A reduction valve 36 is connected in the clamping pressure line 32. The reduction valve 36 is set to reduce the pressure produced in the clamping pressure line 32 when the operator controls the directional valve 66 to clamp the object 20 to an initial pressure that causes the gripping arms of the clamping assembly to clamp the object 20 by a low non-destructive force. When the gripping arms 18 contact the object 20, the hydraulic rams 16 stop their movement, whereby the pressure in the return line 34 from these cylinders decreases to near zero by the valve 66 directing the return line 34 to tank 54. A check valve 38 openable by the clamping pressure in the clamping pressure line 32—and by opening pressure through a pilot line 40 in the return line 34—makes sure that the gripping arms 18 do not open accidentally if the pressure drops in the clamping pressure line 32.

A pressure switch 44 senses the pressure in the return line 34 via a line 42 and is connected to an electromagnetically controlled locking valve 48 via a pilot line 46. The locking valve 48 and an adjustable hydraulic pressure amplifier 52 are connected in series in a line 50 that connects the clamping pressure line 32 and the lifting pressure line 58 to each other between the valve arrangement 66 and the reduction valve 36.

The hydraulic pressure amplifier 52 is a well-known hydraulic construction element which in the embodiment according to FIG. 1 is connected in such a manner that it is capable of letting hydraulic flow through only in the direction from the clamping pressure line 32 to the lifting pressure line 58. The pressure amplifier 58 is thereby capable of controlling the pressure in the clamping line 32 to a value that is higher than the pressure in the lifting pressure line 58 by an amount that is determined by the setting of the pressure amplifier 52. Accordingly, in this case the pressure amplifier 52 is responsible for that the lifting pressure p_{L} in the lifting pressure line 30 continuously corresponds to the clamping pressure p_{C} reduced by a constant value Δp that depends on the setting of the pressure amplifier.

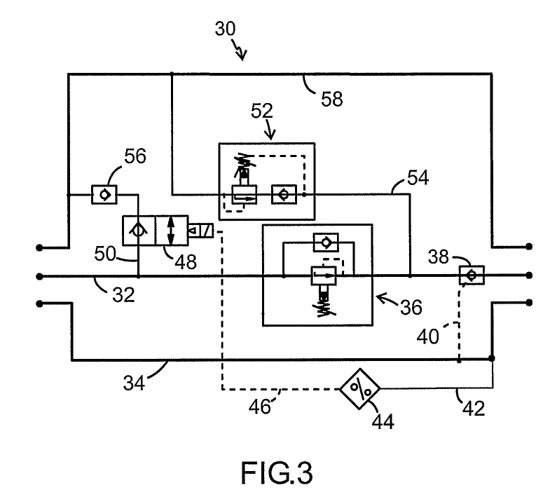

The sequence valves shown in FIGS. 2 and 3 are suitably used as the pressure amplifier 52. In the embodiment shown these valves are pilot controlled relief valve capable of sensing differential pressure. Other hydraulic constructional elements such as throttle valves or other types of relief valves (not shown) may, however, also be used as pressure amplifiers 52.

When pressure is present in the return line 34, the locking valve 48 receives no signal in the control line 46 from the pressure switch 44 and then holds the locking valve 48 closed in the position shown in FIG. 1. When. as described above, the pressure in the return line drops to near zero, the pressure switch 44 closes, resulting in the opening of the locking valve 48. The flow from valve 66 is then branched to the pressure amplifier 52 towards the lifting actuator 12 and to a bypass line 54, whereby a check valve 56 opens to the clamping actuators 16. This results on the one hand in an increasing pressure being developed on the one hand in the lifting pressure line 58 (lifting pressure p_{L}) against the weight of the load consisting of the clamping assembly 14 including the object 20, and on the other hand in the clamping pressure line 32 (clamping pressure p_{C}) against the reaction force from the object 20. During the full clamping and lifting operation and until the load is relieved from the ground, the pressure amplifier 52 sees to that the constant difference pressure Δp is maintained between the clamping pressure p_{C} and the lifting pressure p_{L}.

In the embodiment according to FIG. 1 the clamping pressure p_{C} is the higher pressure. The constant difference pressure Δp set in the pressure amplifier 52 is empirically determined from known load situations and may typically amount to about 3 MPa (30 bar). Such an empirically determined difference pressure may then usually be used invariably in most load situations at a load handling site, by the same assembly, for example to optionally handle one, two, three or four printing paper rolls in a paper mill or a newspaper printing plant.

The necessary difference pressure is in reality determined by the frictional conditions that are present in the engaging faces between the gripping arms and the objects and that varies inter alia in dependence of the size, structure and material of the engagement faces.

Accordingly, depending on varying frictional coefficient between the gripping arms and the object, the difference pressure Δp may be varied upwards and downwards and also to be negative, i.e. the lifting pressure may need to be larger than the clamping pressure. In such a case having a relatively large frictional coefficient, a modified clamp force control 30 according to FIG. 1 may be used.

The embodiment according to FIG. 3 differs from that of FIG. 2 in principle only by the pressure amplifier 52 having been reversed to raise the pressure in the lifting pressure line 58 instead of the clamping pressure line 32.

1. A clamp force control (30) for a fluid powered clamping and lifting assembly (10) adapted to clamp and lift objects (20) by friction engagement in clamping and lifting operations by clamping pressure in a clamping pressure line (32) and lifting pressure in a lifting pressure line (58) provided for respective clamping actuators (16) and lifting actuators (12) of the assembly, characterised by an adjustable pressure amplifier (52) provided in fluid connection (50) between the clamping pressure line (32) and the lifting pressure line (58) and adapted to provide a predetermined, constant difference between the lifting pressure and the clamping pressure.

2. The clamp force control according to claim 1, wherein the pressure amplifier (52) is a pilot controlled relief valve capable of sensing differential pressure.

3. The clamp force control according to claim 1, comprising a locking valve (48) in the fluid connection (50) between the clamping pressure line (32) and the lifting pressure line (58) to prevent accidental pressure transfer from the clamping pressure line (32) to the lifting pressure line (58).

4. The clamp force control according to claim 3, comprising a pressure switch (44) for sensing fluid pressure in a return line (34) for said clamping actuator (16) and adapted for signalling opening of the locking valve (48) to allow transfer of fluid pressure from the clamping pressure line (32) to the lifting pressure line (58) when the pressure in the return line (34) is below a predetermined level.

5. The clamp force control claim 1, comprising a reduction valve (35) adapted to reduce the clamping pressure to a low initial pressure before each clamping and lifting operation in order to clamp the object (20) by a low, non-destructive force.

6. A clamping and lifting assembly provided with a clamp force control (30) according to claim 1.
